(19) United States
(12) Patent Application Publication
(10) Pub. No.: US 2022/0056159 A1
(43) Pub. Date: Feb. 24, 2022

(54) METHOD FOR JOINT RECOVERY OF PECTIN FROM CITRUS PEELS AND ALKALINE/ACIDIC PROCESSING WATER FROM CITRUS CANNING

(71) Applicant: Zhejiang University, Zhejiang (CN)

(72) Inventors: Jianle Chen, Zhejiang (CN); Xingqian Ye, Zhejiang (CN); Huan Cheng, Zhejiang (CN); Shiguo Chen, Zhejiang (CN); Donghong Liu, Zhejiang (CN)

(21) Appl. No.: 17/299,116

(22) PCT Filed: Jun. 9, 2020
(86) PCT No.: PCT/CN2020/095220

§ 371 Date: Jun. 2, 2021

(30) Foreign Application Priority Data
Jun. 30, 2019 (CN) 201910581942.6
Jun. 30, 2019 (CN) 201910581971.2

(51) Int. Cl. C08B 37/00

(52) U.S. Cl. CPC C08B 37/0048; C08B 37/0003

(57) ABSTRACT

Disclosed is a method for joint recovery of pectin from citrus peels and alkaline/acidic processing water from citrus canning, including the following steps: adding fresh citrus fruit peels to alkali/acid processing water from citrus fruit canning for extracting; filtering the resulting mixture, adding to the resulting filtrate 95% ethanol 1 to 3 times the volume of the filtrate, and then adjusting the pH to a range of 3.5 to 7, followed by standing for 10 minutes to 4 hours; filtering the product after standing, washing the resulting precipitate with 50% to 70% ethanol, and drying and crushing, thereby obtaining pectin. The method makes full use of waste resources from citrus fruit canning, solves the problem of pollution by processing discharge water, and has the advantages of saving the preparation cost of pectin from citrus peels, and improving the solubility of recovered pectin.

### CROSS REFERENCE TO RELATED APPLICATIONS

This application is a U.S. National Phase Application of PCT/CN2020/095220; filed Jun. 9, 2020, which claims benefit of priority to Chinese Patent Application No. 201901581971.2, filed Jun. 30, 2019 and Chinese Patent Application No. 201910581942.6, filed Jun. 30, 2019. The contents of these applications being incorporated herein by reference in their entirety.

### TECHNICAL FIELD

The present disclosure belongs to the field of comprehensive utilization of fruit and vegetable canning wastes, and in particular relates to a method for joint recovery of pectin from citrus peels and alkaline/acidic processing water from citrus canning.

### BACKGROUND OF INVENTION

Citrus fruits are probably the best known and most common fruits all over the word. In 2016, the world's citrus planting area was 9453.5 thousand hectares, with the yield of 146.429 million tons. Loose-skin citrus fruits, which are very common, can be processed into canned citrus fruits. This is a good way to expand the time and space for selling of citrus fruit products, which not only overcomes the disadvantage of difficult storage and transportation of fruits but also results in enriched taste of citrus fruit products, improved edibleness, and increased processing added value of agricultural citrus fruit products.

The citrus fruit canning process includes the steps of blanching, peeling and separating into segments, acid-alkali treatment for membrane removing, and rinsing, and features low resource utilization and high pollution. The acid-alkali treatment step is a process of hydrolyzing segments with acid and alkali successively to remove the citrus segment membrane, in which the membrane may be first decomposed and partially softened and dissolved in an acid trough. Thus, the resulting acid processing water would contain membrane organics dissolved therein and have a high chemical oxygen demand (COD), approximately 10000 mg/L, and therefore cannot be discharged directly because it may easily cause pollution such as water eutrophication. On the basis of the treatment in the acid trough, the membrane may be further subjected to decomposition and complete dissolution and removal in an alkali trough, thus resulting in alkali processing water containing a large amount of membrane organics dissolved therein and having a high chemical oxygen demand (COD), approximately 10000 mg/L. Likewise, the alkali processing water cannot be discharged directly because it may easily cause pollution such as water eutrophication. Pectin is one of the main membrane components in alkali processing water and a main obstacle factor to COD reduction treatment of the alkali processing water. Therefore, the recovery of pectin from the alkali processing water can have dual effects of improving citrus resource utilization and reducing COD of discharge water.

The specific process of the acid-alkali membrane removal as described above is explicitly revealed in “Manuals of Canning Industry” (Manual of Canning Industry, edited by Liang Bangying and published by China Light Industry Press). The properties of acid/alkali processing water are as follows:

The acid processing water from citrus segment membrane removal may have a pH of about 1, about 0.7% of total solids, about 0.1 to 0.3% of pectin, and about 0.07% of total flavonoids.

The alkali processing water from citrus segment membrane removal may have a pH of about 13, about 1.3% of total solids, about 0.2 to 0.5% of pectin, and about 0.003% of total flavonoids.

On the other hand, citrus fruit peels are an important waste resource from citrus fruit canning. For the convenience of storage and transportation of citrus fruit peels, it is currently a common practice to pre-dry the citrus fruit peels before transportation and sales to downstream manufacturers that use citrus fruit peels as the raw material for production of dried citrus fruit peels, essential oil, pectin, etc., with significantly increased processing cost of the citrus fruit peels due to pre-drying and transportation thereof.

Citrus fruit peels are one of the main sources of commercial pectin product. Pectin can be widely used as thickener and gelling agent in food processing, which, however, is currently in short supply. The commercial pectin product can be obtained by the steps of subjecting citrus fruit peels to drying, crushing and extracting (generally at 70 to 100° C. for 1 to 2 hours with an inorganic acid as extracting agent), as well as filtering, adjusting the pH of the filtrate to a range of 3.5 to 7, alcohol precipitating (adding food grade ethanol to the filtrate to fully precipitate the pectin in the filtrate), filtering, drying, etc.

There have been some reports on the recovery of pectin from citrus fruit canning processing water.

Chinese invention patent No. CN103122039A, incorporated by reference herein, discloses a process for recovering pectin from acid processing water generated during citrus fruit canning, which can be summarized as pH adjustment of acid discharge water to neutral, followed by preliminary impurity removal by filtration using a cloth bag, two-step membrane filtration and separation of the filtrate and spray drying of the separated liquid, thus obtaining the pectin. Another Chinese invention patent (CN102745836A, incorporated by reference herein) discloses a method for treatment of citrus fruit canning production processing water, which can be summarized as firstly impurity removal by plate-frame pressure filtration with diatomite, followed by nanofiltration and ultrafiltration after pH adjustment, precipitation of the resulting concentrate, and centrifuging and drying of the precipitate, thereby obtaining pectin. A further method that can be used in the precipitation process is salting out. Pectin recovery from acid processing water, however, may have the problems of relatively low yield, high cost, and difficult filtration due to fine particles of citrus segment membrane present in the acid processing water, as well as poor solubility of dried pectin. There is no solution reported so far to on-site combined pectin recovery from citrus fruit peels and acid processing water, with cost sharing and quality improvement of pectin.

In addition, it is usually used in the prior art to extract pectin from the alkali discharge liquid of citrus fruit canning by the process of pretreating for large-grained impurity removal, adjusting the pH to neutral, followed by two-step membrane filtration and separation, and spray drying of the separated liquid, thereby obtaining pectin (CN103122038A, incorporated herein by reference). Similarly, pectin recovery from alkali processing water may have the problems of relatively low yield, high cost, and difficult filtration due to fine particles of citrus segment membrane present in the alkali processing water, as well as poor solubility of dried pectin. There is also no solution reported so far to on-site combined pectin recovery from citrus fruit peels and alkali processing water, with cost sharing and quality improvement of pectin.

### SUMMARY OF THE INVENTION

The present disclosure is intended to provide a method for joint recovery of pectin from citrus peels and alkaline/acidic processing water from citrus canning. The method can make full use of waste resources from citrus fruit canning, solve the problem of pollution by processing discharge water and have the advantages of saving the preparation cost of pectin from citrus fruit peels, reducing the filtering difficulty of pectin from alkali/acid processing water, and improving the solubility of recovered pectin.

To solve the technical problems as described above, the present disclosure provides a method for joint recovery of pectin from citrus peels and alkaline/acidic processing water from citrus canning, including the following steps:

1) carrying out extraction:

using a method I when involved with alkali processing water from citrus segment membrane removal, and using a method II when involved with acid processing water from citrus segment membrane removal,

where the method I for alkali processing water from citrus fruit canning is as follows:

mixing fresh citrus fruit peels with alkali processing water from citrus segment membrane removal (i.e., alkali processing water containing components such as pectin) stirring at 10 to 40° C. for 5 minutes to 30 minutes;

the method II for acid processing water from citrus fruit canning is as follows:

mixing fresh citrus fruit peels with acid processing water from citrus segment membrane removal (i.e., acid processing water containing components such as pectin) and stirring at 70 to 95° C. for 60 minutes to 100 minutes;

where a pectin extract is obtained from step 1;

2) filtering the pectin extract from step 1, adding to a resulting filtrate 95% (by volume) ethanol 1 to 3 times the volume of the filtrate, and adjusting pH to a range of 3.5 to 7, followed by standing (precipitating) for 10 minutes to 4 hours;

where the pH is preferably 5.5 to 6.8 for method I, and preferably 3.5 for method II;

3) filtering the product from standing in step 2, washing resulting precipitate with 50% to 70% (by volume) ethanol once or twice, followed by drying and crushing, thereby obtaining pectin.

As an improvement to the method for joint recovery of pectin from citrus peels and alkaline/acidic processing water from citrus canning of the present disclosure:

in the method I, a ratio of the fresh citrus fruit peels to the alkali processing water from citrus segment membrane removal may be 1 g:(10-15) ml; and

in the method II, a ratio of the fresh citrus fruit peels to the acid processing water from citrus segment membrane removal may be 1 g:(10-15) ml.

As an improvement to the method for joint recovery of pectin from citrus peels and alkaline/acidic processing water from citrus canning of the present disclosure:

the method I may be as follows: mixing the fresh citrus fruit peels with the alkali processing water from citrus segment membrane removal and stirring after shearing homogenization; and

the method II may be as follows: mixing the fresh citrus fruit peels with the acid processing water from citrus segment membrane removal and stirring after shearing homogenization.

As an improvement to method for joint recovery of pectin from citrus peels and alkaline/acidic processing water from citrus canning of the present disclosure:

the method I may be as follows:

firstly mixing the fresh citrus fruit peels with the alkali processing water from citrus segment membrane removal in a ratio of 1 g:(1-2) ml, followed by shearing homogenization, then adding the alkali processing water from citrus segment membrane removal until a ratio of the fresh citrus fruit peels to the total alkali processing water from citrus segment membrane removal is 1 g:(10-15) ml, and finally stirring at 10 to 40° C. for 5 minutes to 30 minutes; and

the method II may be as follows:

firstly mixing the fresh citrus fruit peels with the acid processing water from citrus segment membrane removal in a ratio of 1 g:(1-2) ml, followed by shearing homogenization, then adding the acid processing water from citrus segment membrane removal until a ratio of the fresh citrus fruit peels to the total acid processing water from citrus segment membrane removal is 1 g:(10-15) ml, and finally stirring at 70 to 95° C. for 60 minutes to 100 minutes.

By shearing homogenization, the fresh citrus fruit peels can be crushed to a certain extent, which is conducive to extraction of pectin from the citrus fruit peels. Such a two-step processing water addition method can result in improved extraction efficiency from the fresh citrus fruit peels.

As an improvement to the method for joint recovery of pectin from citrus peels and alkaline/acidic processing water from citrus canning of the present disclosure:

the shearing homogenization may be shearing at 200 r/min for 2 minutes.

As an improvement to the method for joint recovery of pectin from citrus peels and alkaline/acidic processing water from citrus canning of the present disclosure:

the filtering in each of the steps 2) and 3) may be conducted by a 300 to 400-mesh screen.

As an improvement to the method for joint recovery of pectin from citrus peels and alkaline/acidic processing water from citrus canning of the present disclosure:

in the method I, stirring may be carried out at 20 to 30° C. for 10 to 20 minutes, for example, at 30° C. for 15 minutes; and

in the method II, stirring may be carried out while heating at 85° C. for 80 to 90 minutes.

The above-described solution can take into consideration both extraction efficiency and extraction cost.

As an improvement to the method for joint recovery of pectin from citrus peels and alkaline/acidic processing water from citrus canning of the present disclosure:

for alkali processing water from citrus fruit canning, the step 2 may include: filtering with a 300 to 400-mesh screen, precipitating with 95% (by volume) ethanol 1 to 2 times the volume of the filtrate, adjusting the pH to a range of 5.5 to 6.5, and standing (precipitating) for 30 to 60 minutes, and preferably filtering with a 350-mesh screen, precipitating with 95% (by volume) ethanol 1 time the volume of the filtrate, adjusting the pH to 6.5, and standing (precipitating) for 45 minutes; and

for acid processing water from citrus segment membrane removal, the step 2 may include: filtering with a 350 to 400-mesh screen, precipitating with 95% (by volume) ethanol 1 to 2 times the volume of the filtrate, adjusting the pH to 3.5, and standing (precipitating) for 30 to 45 minutes.

As an improvement to the method for joint recovery of pectin from citrus peels and alkaline/acidic processing water from citrus canning of the present disclosure:

for alkali processing water from citrus fruit canning, the step 3) may include: filtering with a 350-mesh screen and washing the resulting precipitate with 60 to 70% (by volume) ethanol; and

for acid processing water from citrus segment membrane removal, the step 3) may include: filtering with a 350-mesh screen and washing the resulting precipitate with 60 to 70% (by volume) ethanol.

The above-described solution can achieve the purpose of cost-efficient washing without loss of pectin.

Compared with the prior art, the present disclosure may have the following advantages:

(1) Citrus fruit peels by-product from citrus fruit canning can be used locally for on-site production without drying and transportation. Without long term storage and long distance transportation of citrus fruit peels, fresh citrus fruit peels can be directly used for extraction of pectin, and crushing of dried citrus fruit peels is omitted. Thus, the difficulty and the duration of pectin extraction process can be greatly reduced, with significantly saving the cost of citrus peels pre-treatment.

(2) Using alkali/acid processing water from citrus segment membrane removal in citrus fruit canning as pectin extractant for citrus peel extraction, without additional preparation of extractant, the cost can be obviously reduced without extractant preparation when compared with commercial pectin production. Besides, the utilization of the alkali/acid processing water from citrus segment membrane removal can be of great significance for environmental protection.

(3) In combined recovery of pectin from alkali/acid processing water from citrus segment membrane removal and citrus fruit peels, citrus fruit peels with large particles can act as filter aid to a certain extent, thus resulting in improved filtration over that in single recovery of pectin from alkali/acid processing water.

(4) The pectin obtained by combined recovery can have better solubility due to lowered pectin aggregation in the combined recovery from alkali/acid processing water from citrus segment membrane removal and citrus fruit peels as compared with that in single recovery of pectin from alkali/acid processing water.

### DETAILED DESCRIPTION OF THE INVENTION

The present disclosure is now further described in conjunction with specific examples, but the protection scope of the present disclosure is not limited thereto.

### I. PROCESS FOR COMBINED RECOVERY OF PECTIN FROM CITRUS FRUIT PEELS AND ALKALI PROCESSING WATER FROM CITRUS FRUIT CANNING (“ALKALI PROCESSING WATER FROM CITRUS FRUIT CANNING” IS EQUAL TO “ALKALI PROCESSING WATER FROM CITRUS SEGMENT MEMBRANE REMOVAL” IN THIS DISCLOSURE)

In the present disclosure, hydrochloric acid solution at the concentration of 1% was employed in pH adjustment. The alkali processing water from citrus segment membrane removal was alkali processing water from citrus fruit canning.

### EXAMPLE 1-1

Fresh citrus fruit peels from citrus fruit canning were added to the alkali processing water from citrus segment membrane removal in a ratio of 1 g:10 ml and then subjected to shearing at 200 r/min for 2 minutes, stirring at 30° C. for 10 minutes, and filtering with a 350-mesh screen. Then, the filtrate was collected and precipitated with 95% ethanol 2 times the volume of the filtrate (for alcohol precipitation), followed by pH adjustment to 5.5, standing for 30 minutes, precipitation, and separation of precipitate by filtering with a 350-mesh screen. The precipitate was washed with 70% ethanol once (a mass ratio of washing solution used to the precipitate was 2:1), dried (at 40° C. for 24 hours), and crushed (sieving through a 60-mesh screen after the crushing), thereby obtaining pectin.

The pectin obtained by combined recovery had a yield of 6.8% (based on the wet weight of the citrus fruit peels).

The pectin extract was filtered at a rate of 780 ml/min per square meter of filter cloth, and the solubility of pectin reached 91% after the solution stirring for 15 minutes.

### EXAMPLE 1-2

Fresh citrus fruit peels from citrus fruit canning were added to the alkali processing water from citrus segment membrane removal such that a ratio of the citrus fruit peels to the alkali processing water was firstly 1:1, and subjected to shearing at 200 r/min for 2 minutes. The alkali processing water from citrus segment membrane removal was then added until the ratio of the citrus fruit peels to the processing water was 1:10, followed by stirring at 30° C. for 10 minutes and filtering with a 350-mesh screen. Then, the filtrate was collected and precipitated with 95% ethanol 2 times the volume of the filtrate, followed by pH adjustment to 5.5, standing for 30 minutes, precipitation, and separation of precipitate by filtering with a 350-mesh screen. The precipitate was washed with 70% ethanol once, dried and crushed, thereby obtaining pectin.

The pectin obtained by combined recovery had a yield of 7.2% (based on the wet weight of the citrus fruit peels).

The pectin extract was filtered at a rate of 860 ml/min per square meter of filter cloth, and the solubility of pectin reached 93% after the solution stirring for 15 minutes.

### EXAMPLE 1-3

Fresh citrus fruit peels from citrus fruit canning were added to the alkali processing water from citrus segment membrane removal in a ratio of 1:15 and then subjected to shearing at 200 r/min for 3 minutes, stirring at 20° C. for 20 minutes, and filtering with a 300-mesh screen. Then, the filtrate was collected and precipitated with 95% ethanol 1 time the volume of the filtrate, followed by pH adjustment to 6.5, standing for 60 minutes, precipitation, and separation of precipitate by filtering with a 350-mesh screen. The precipitate was washed with 60% ethanol once, dried and crushed, thereby obtaining pectin.

The pectin obtained by combined recovery had a yield of 6.3% (based on the wet weight of the citrus fruit peels).

The pectin extract was filtered at a rate of 840 ml/min per square meter of filter cloth, and the solubility of pectin reached 90% after the solution stirring for 15 minutes.

### EXAMPLE 1-4

Fresh citrus fruit peels from citrus fruit canning were added to the alkali processing water from citrus segment membrane removal such that a ratio of the citrus fruit peels to the alkali processing water was firstly 1:2, and subjected to shearing at 200 r/min for 3 minutes. The alkali processing water from citrus segment membrane removal was then added until the ratio of the citrus fruit peels to the processing water was 1:15, followed by stirring at 20° C. for 20 minutes and filtering with a 300-mesh screen. Then, the filtrate was collected and precipitated with 95% ethanol 1 time the volume of the filtrate, followed by pH adjustment to 6.5, standing for 60 minutes, precipitation, and separation of precipitate by filtering with a 350-mesh screen. The precipitate was washed with 60% ethanol once, dried and crushed, thereby obtaining pectin.

The pectin obtained by combined recovery had a yield of 6.8% (based on the wet weight of the citrus fruit peels).

The pectin extract was filtered at a rate of 900 ml/min per square meter of filter cloth, and the solubility of pectin reached 92% after the solution stirring for 15 minutes.

### Comparative Example 1

This example was the same as example 1-1 everywhere except for “shearing at 200 r/min for 2 minutes” which was omitted here, and as a result, the pectin obtained by combined recovery had a yield of 5.8% (based on the wet weight of the citrus fruit peels). The pectin extract was filtered at a rate of 670 ml/min per square meter of filter cloth, and the solubility of pectin reached 89% after the solution stirring for 15 minutes.

### Comparative Example 2-1

According to the existing process of obtaining commercial pectin product, fresh citrus fruit peels were subjected to the steps of citrus fruit peels drying, crushing, extraction, alcohol precipitation, etc. to obtain the commercial pectin product. The process steps and parameters were specifically as follows: the citrus fruit peels were dried at 50° C. for 48 hours, crushed to a size of about 1 mm, added with hydrochloric acid with pH 1.5 and a ratio of the citrus fruit peels to the acid of 1:30 for extraction at 85° C. for 90 minutes, followed by filtering with a 300-mesh screen. The filtrate was collected and precipitated with 1 time 95% ethanol, followed by standing for 60 minutes, precipitation, and separation of precipitate by filtering with a 350-mesh screen. The precipitate was washed with 60% ethanol once, dried and crushed, thereby obtaining pectin.

As a result, the pectin had a yield of 4.3% (based on the wet weight of the citrus fruit peels).

The pectin extract was filtered at a rate of 950 ml/min per square meter of filter cloth, and the solubility of pectin reached 93% after the solution stirring for 15 minutes.

In contrast to the technical solutions of the present disclosure, it was necessary in this method to pre-dry the citrus fruit peels before crushing and to prepare a hydrochloric acid solution additionally, leading to greatly increased cost and increased water consumption. Besides, the method failed to recover pectin from ready-made alkali processing water from citrus segment membrane removal.

### Comparative Example 2-2

The alkali processing water from citrus segment membrane removal (i.e., the alkali processing water from citrus fruit canning) was directly subjected to the steps of filtering, alcohol precipitation, drying, crushing, etc. to obtain pectin recovered from alkali processing water. The process steps and parameters were specifically as follows: after filtering with a 350-mesh screen of the alkali processing water from citrus segment membrane removal, the filtrate was collected and added with 2 volumes 95% ethanol, followed by pH adjustment to 5.5, standing for 30 minutes, precipitation, and separation of precipitate by filtering with a 350-mesh screen. The precipitate was washed with 70% ethanol once, dried and crushed, thereby obtaining pectin.

As a result, the alkali processing water from citrus segment membrane removal was filtered at a rate of 630 ml/min per square meter of filter cloth, and the solubility of pectin was 67% after the solution stirring for 15 minutes.

Thus, compared with example 1-2, a lower filtering rate in single recovery of pectin from the alkali processing water from citrus segment membrane removal and weaker solubility of pectin due to easy aggregation in single recovery could be observed here.

### Comparative Example 3-1

The ratio of the citrus fruit peels to the processing water was changed from “1:10” as used in example 1-2 to “1:5”, and the rest was the same with example 1-2. As a result, the pectin obtained by combined recovery had a yield of 6.7% (based on the wet weight of the citrus fruit peels). The pectin extract was filtered at a rate of 770 ml/min per square meter of filter cloth, and the solubility of pectin reached 92% after the solution stirring for 15 minutes.

### Comparative Example 3-2

The ratio of the citrus fruit peels to the processing water was changed from “1:10” as used in example 1-2 to “1:20”, and the rest was the same with example 1-2. As a result, the pectin obtained by combined recovery had a yield of 7.2% (based on the wet weight of the citrus fruit peels). The pectin extract was filtered at a rate of 910 ml/min per square meter of filter cloth, and the solubility of pectin reached 93% after the solution stirring for 15 minutes.

In spite of a slightly higher filtering rate over example 1-2, the time of filtering was dramatically increased due to greatly increased volume of the extract, and the amount of ethanol used in alcohol precipitation was significantly increased. Therefore, this method would not be recommended.

### II. PROCESS FOR COMBINED RECOVERY OF PECTIN FROM CITRUS FRUIT PEELS AND ACID PROCESSING WATER FROM CITRUS FRUIT CANNING (“ACID PROCESSING WATER FROM CITRUS FRUIT CANNING” IS EQUAL TO “ACID PROCESSING WATER FROM CITRUS SEGMENT MEMBRANE REMOVAL” IN THIS DISCLOSURE)

In the present disclosure, sodium hydroxide solution at the concentration of 1% was employed in pH adjustment. The acid processing water from citrus segment membrane removal was acid processing water from citrus fruit canning.

### EXAMPLE 2-1

Fresh citrus fruit peels from citrus fruit canning were added to the acid processing water from citrus segment membrane removal in a ratio of 1:10 (g/ml) and then subjected to shearing at 200 r/min for 2 minutes, stirring while heating at 85° C. for 90 minutes, and filtering with a 350-mesh screen. Then, the filtrate was collected and added with 95% ethanol 2 times the volume of the filtrate (for alcohol precipitation), followed by pH adjustment to 3.5, standing for 30 minutes, precipitation, and separation of precipitate by filtering with a 350-mesh screen. The precipitate was washed with 70% ethanol once (a mass ratio of washing solution used to the precipitate was 2:1), dried (at 40° C. for 24 hours), and crushed (60-mesh sieving after the crushing), thereby obtaining pectin.

The pectin obtained by combined recovery had a yield of 5.9% (based on the wet weight of the citrus fruit peels).

The pectin extract was filtered at a rate of 760 ml/min per square meter of filter cloth, and the solubility of pectin reached 91% after the solution stirring for 15 minutes.

### EXAMPLE 2-2

Fresh citrus fruit peels from citrus fruit canning were added to the acid processing water from citrus segment membrane removal such that a ratio of the citrus fruit peels to the alkali processing water was firstly 1:1, and subjected to shearing at 200 r/min for 2 minutes. The acid processing water from citrus segment membrane removal was then added until the ratio of the citrus fruit peels to the processing water was 1:10, followed by stirring while heating at 85° C. for 90 minutes and filtering with a 350-mesh screen. Then, the filtrate was collected and added with 95% ethanol 2 times the volume of the filtrate, followed by pH adjustment to 3.5, standing for 30 minutes, precipitation, and separation of precipitate by filtering with a 350-mesh screen. The precipitate was washed with 70% ethanol once, dried and crushed, thereby obtaining pectin.

The pectin obtained by combined recovery had a yield of 6.2% (based on the wet weight of the citrus fruit peels).

The pectin extract was filtered at a rate of 830 ml/min per square meter of filter cloth, and the solubility of pectin reached 93% after the solution stirring for 15 minutes.

### EXAMPLE 2-3

Fresh citrus fruit peels from citrus fruit canning were added to the acid processing water from citrus segment membrane removal such that a ratio of the citrus fruit peels to the alkali processing water was firstly 1:1, and subjected to shearing at 200 r/min for 2 minutes. The acid processing water from citrus segment membrane removal was then added until the ratio of the citrus fruit peels to the processing water was 1:10, followed by stirring while heating at 85° C. for 80 minutes and filtering with a 400-mesh screen. Then, the filtrate was collected and added with 95% ethanol 1 time the volume of the filtrate, followed by pH adjustment to 3.5, standing for 45 minutes, precipitation, and separation of precipitate by filtering with a 350-mesh screen. The precipitate was washed with 60% ethanol once, dried and crushed, thereby obtaining pectin.

The pectin obtained by combined recovery had a yield of 6.1% (based on the wet weight of the citrus fruit peels).

The pectin extract was filtered at a rate of 800 ml/min per square meter of filter cloth, and the solubility of pectin reached 93% after the solution stirring for 15 minutes.

### EXAMPLE 2-4

Fresh citrus fruit peels from citrus fruit canning were added to the acid processing water from citrus segment membrane removal such that a ratio of the citrus fruit peels to the alkali processing water was firstly 1:2, and subjected to shearing at 200 r/min for 2 minutes. The acid processing water from citrus segment membrane removal was then added until the ratio of the citrus fruit peels to the processing water was 1:15, followed by stirring while heating at 85° C. for 80 minutes and filtering with a 400-mesh screen. Then, the filtrate was collected and added with 95% ethanol 1 time the volume of the filtrate, followed by pH adjustment to 3.5, standing for 45 minutes, precipitation, and separation of precipitate by filtering with a 350-mesh screen. The precipitate was washed with 60% ethanol once, dried and crushed, thereby obtaining pectin.

The pectin obtained by combined recovery had a yield of 6.2% (based on the wet weight of the citrus fruit peels).

The pectin extract was filtered at a rate of 840 ml/min per square meter of filter cloth, and the solubility of pectin reached 93% after the solution stirring for 15 minutes.

### Comparative Example 4

This example was the same as example 2-1 everywhere except for “shearing at 200 r/min for 2 minutes” which was omitted here, and as a result, the pectin obtained by combined recovery had a yield of 4.9% (based on the wet weight of the citrus fruit peels). The pectin extract was filtered at a rate of 640 ml/min per square meter of filter cloth, and the solubility of pectin reached 89% after the solution stirring for 15 minutes.

### Comparative Example 5-1

According to the existing process of obtaining commercial pectin product, fresh citrus fruit peels were subjected to the steps of citrus fruit peels drying, crushing, extraction, alcohol precipitation, etc. to obtain the commercial pectin product. The process steps and parameters were specifically as follows: the citrus fruit peels were dried at 50° C. for 48 hours, crushed to a size of about 1 mm, added with hydrochloric acid with pH 1.5 and a ratio of the citrus fruit peels to the acid of 1:30 for extraction at 85° C. for 90 minutes, followed by filtering with a 300-mesh screen. The filtrate was collected and added with 1 time 95% ethanol, followed by standing for 60 minutes, precipitation, and separation of precipitate by filtering with a 350-mesh screen. The precipitate was washed with 60% ethanol once, dried and crushed, thereby obtaining pectin.

As a result, the pectin had a yield of 4.3% (based on the wet weight of the citrus fruit peels).

The pectin extract was filtered at a rate of 950 ml/min per square meter of filter cloth, and the solubility of pectin reached 93% after the solution stirring for 15 minutes.

In contrast to the technical solutions of the present disclosure, it was necessary in this method to pre-dry the citrus fruit peels before crushing and to prepare a hydrochloric acid solution additionally, leading to greatly increased cost and increased water consumption. Besides, the method failed to recover pectin from ready-made acid processing water from citrus segment membrane removal.

### Comparative Example 5-2

The acid processing water from citrus segment membrane removal (i.e., the acid processing water from citrus fruit canning) was directly subjected to the steps of filtering, alcohol precipitation, drying, crushing, etc. to obtain pectin recovered from acid processing water. The process steps and parameters were specifically as follows: after filtering with a 350-mesh screen of the acid processing water from citrus segment membrane removal, the filtrate was collected and added with 2 times 95% ethanol, followed by pH adjustment to 3.5, standing for 30 minutes, precipitation, and separation of precipitate by filtering with a 350-mesh screen. The precipitate was washed with 70% ethanol once, dried and crushed, thereby obtaining pectin.

As a result, the acid processing water from citrus segment membrane removal was filtered at a rate of 590 ml/min per square meter of filter cloth, and the solubility of pectin was 65% after the solution stirring for 15 minutes.

Thus, compared with example 2-2, a lower filtering rate in single recovery of pectin from the acid processing water from citrus segment membrane removal and weaker solubility of pectin due to easy aggregation in single recovery could be observed here.

### Comparative Example 6-1

The ratio of the citrus fruit peels to the processing water was changed from “1:10” as used in example 2-2 to “1:5”, and the rest was the same with example 2-2. As a result, the pectin obtained by combined recovery had a yield of 5.9% (based on the wet weight of the citrus fruit peels). The pectin extract was filtered at a rate of 740 ml/min per square meter of filter cloth, and the solubility of pectin reached 92% after the solution stirring for 15 minutes.

### Comparative Example 6-2

The ratio of the citrus fruit peels to the processing water was changed from “1:10” as used in example 2-2 to “1:20”, and the rest was the same with example 2-2. As a result, the pectin obtained by combined recovery had a yield of 6.2% (based on the wet weight of the citrus fruit peels). The pectin extract was filtered at a rate of 870 ml/min per square meter of filter cloth, and the solubility of pectin reached 93% after the solution stirring for 15 minutes.

In spite of a slightly higher filtering rate over example 2-2, the time of filtering was dramatically increased due to greatly increased volume of the extract, and the amount of ethanol used in alcohol precipitation was significantly increased. Therefore, this method would not be recommended.

Finally, it should be noted that the examples listed above are merely a few specific examples of the present disclosure. Apparently, the present disclosure would not be limited to the above examples, and many variations are possible. All modifications that can be directly derived or conceived by a person of ordinary skill in the art from the specification of the present disclosure should be regarded as falling into the protection scope of the present disclosure.

1.-9. (canceled)

10. A method for joint recovery of pectin from citrus peels and alkaline/acidic processing water from citrus canning, comprising the following steps:
step 1, carrying out extraction:
using a method I when involved with alkali processing water from citrus fruit canning, and using a method II when involved with acid processing water from citrus fruit canning,
wherein the method I for alkali processing water from citrus fruit canning is as follows:
mixing fresh citrus fruit peels with alkali processing water from citrus segment membrane removal and stirring at 10 to 40° C. for 5 to 30 minutes;
the method II for acid processing water from citrus fruit canning is as follows:
mixing fresh citrus fruit peels with acid processing water from citrus segment membrane removal and stirring at 70 to 95° C. for 60 to 100 minutes;
step 2, filtering the mixture from step 1, adding to a resulting filtrate 95 vol % ethanol 1 to 3 times the volume of the filtrate, and adjusting pH to a range of 3.5 to 7, followed by standing for 10 minutes to 4 hours; and
step 3, filtering the product from standing in step 2, washing a resulting precipitate with 50 vol % to 70 vol % ethanol once or twice, followed by drying and crushing, thereby obtaining pectin.

11. The method for joint recovery of pectin from citrus peels and alkaline/acidic processing water from citrus canning according to claim 10, wherein:
in the method I, a ratio of the fresh citrus fruit peels to the alkali processing water from citrus segment membrane removal is 1 g:(10-15) ml; and
in the method II, a ratio of the fresh citrus fruit peels to the acid processing water from citrus segment membrane removal is 1 g:(10-15) ml.

12. The method for joint recovery of pectin from citrus peels and alkaline/acidic processing water from citrus canning according to claim 11, wherein:
the method I is as follows: mixing the fresh citrus fruit peels with the alkali processing water from citrus segment membrane removal and stirring after shearing homogenization; and
the method II is as follows: mixing the fresh citrus fruit peels with the acid processing water from citrus segment membrane removal and stirring after shearing homogenization.

13. The method for joint recovery of pectin from citrus peels and alkaline/acidic processing water from citrus canning according to claim 11, wherein:
the method I is as follows:
firstly mixing the fresh citrus fruit peels with the alkali processing water from citrus segment membrane removal in a ratio of 1 g:(1-2) ml, followed by shearing homogenization, then adding the alkali processing water from citrus segment membrane removal until a ratio of the fresh citrus fruit peels to the total alkali processing water from citrus segment membrane removal is 1 g:(10-15) ml, and finally stirring at 10 to 40° C. for 5 minutes to 30 minutes; and
the method II is as follows:
firstly mixing the fresh citrus fruit peels with the acid processing water from citrus segment membrane removal in a ratio of 1 g:(1-2) ml, followed by shearing homogenization, then adding the acid processing water from citrus segment membrane removal until a ratio of the fresh citrus fruit peels to the total acid processing water from citrus segment membrane removal is 1 g:(10-15) ml, and finally stirring at 70 to 95° C. for 60 minutes to 100 minutes.

14. The method for joint recovery of pectin from citrus peels and alkaline/acidic processing water from citrus canning according to claim 12, wherein the shearing homogenization is: shearing at 200 r/min for 2 minutes.

15. The method for joint recovery of pectin from citrus peels and alkaline/acidic processing water from citrus canning according to claim 13, wherein the shearing homogenization is: shearing at 200 r/min for 2 minutes.

16. The method for joint recovery of pectin from citrus peels and alkaline/acidic processing water from citrus canning according to claim 14, wherein:
the filtering in each of the steps 2) and 3) is conducted by a 300 to 400-mesh screen.

17. The method for joint recovery of pectin from citrus peels and alkaline/acidic processing water from citrus canning according to claim 15, wherein:
the filtering in each of the steps 2) and 3) is conducted by a 300 to 400-mesh screen.

18. The method for joint recovery of pectin from citrus peels and alkaline/acidic processing water from citrus canning according to claim 16, wherein:
in the method I, stirring is carried out at 20 to 30° C. for 10 to 20 minutes; and
in the method II, stirring is carried out while heating at 85° C. for 80 to 90 minutes.

19. The method for joint recovery of pectin from citrus peels and alkaline/acidic processing water from citrus canning according to claim 17, wherein:
in the method I, stirring is carried out at 20 to 30° C. for 10 to 20 minutes; and
in the method II, stirring is carried out while heating at 85° C. for 80 to 90 minutes.

20. The method for joint recovery of pectin from citrus peels and alkaline/acidic processing water from citrus canning according to claim 18, wherein:
for alkali processing water from citrus fruit canning, the step 2 comprises: filtering with a 300 to 400-mesh screen, precipitating with 95 vol % ethanol 1 to 2 times the volume of the filtrate, adjusting the pH to a range of 5.5 to 6.5, and standing for 30 to 60 minutes; and
for acid processing water from citrus segment membrane removal, the step 2 comprises: filtering with a 350 to 400-mesh screen, precipitating with 95 vol % ethanol 1 to 2 times the volume of the filtrate, adjusting the pH to 3.5, and standing for 30 to 45 minutes.

21. The method for joint recovery of pectin from citrus peels and alkaline/acidic processing water from citrus canning according to claim 19, wherein:
for alkali processing water from citrus fruit canning, the step 2 comprises: filtering with a 300 to 400-mesh screen, precipitating with 95 vol % ethanol 1 to 2 times the volume of the filtrate, adjusting the pH to a range of 5.5 to 6.5, and standing for 30 to 60 minutes; and
for acid processing water from citrus segment membrane removal, the step 2 comprises: filtering with a 350 to 400-mesh screen, precipitating with 95 vol % ethanol 1 to 2 times the volume of the filtrate, adjusting the pH to 3.5, and standing for 30 to 45 minutes.

22. The method for joint recovery of pectin from citrus peels and alkaline/acidic processing water from citrus canning according to claim 21, wherein:
for alkali processing water from citrus fruit canning, the step 3) comprises: filtering with a 350-mesh screen and washing the resulting precipitate with 60 to 70 vol % ethanol; and
for acid processing water from citrus segment membrane removal, the step 3) comprises: filtering with a 350-mesh screen and washing the resulting precipitate with 60 to 70 vol % ethanol.

23. The method for joint recovery of pectin from citrus peels and alkaline/acidic processing water from citrus canning according to claim 22, wherein:
for alkali processing water from citrus fruit canning, the step 3) comprises: filtering with a 350-mesh screen and washing the resulting precipitate with 60 to 70 vol % ethanol; and
for acid processing water from citrus segment membrane removal, the step 3) comprises: filtering with a 350-mesh screen and washing the resulting precipitate with 60 to 70 vol % ethanol.
